(19) United States
(12) Patent Application Publication
(10) Pub. No.: US 2019/0169702 A1
(43) Pub. Date: Jun. 6, 2019

(54) SUGAR COMPOSITION

(71) Applicant: NUTRITION SCIENCE DESIGN PTE. LTD, Bedok Gardens (SG)

(72) Inventor: David KANNAR, Mount Eliza, Victoria (SG)

(21) Appl. No.: 16/320,630

(22) PCT Filed: Jul. 27, 2017
(86) PCT No.: PCT/AU2017/050782

§ 371 Date: Jan. 25, 2019

(30) Foreign Application Priority Data
Jul. 27, 2016 (AU) 2016902954

(51) Int. Cl. C13B 30/08; C13B 50/00; A23L 33/125; A23L 33/105

(52) U.S. Cl. CPC C13B 30/08; C13B 50/002; A23L 33/125; A23L 33/105; A23V 2200/328; A23V 2250/628; A23V 2250/606; A23V 2250/61; A23V 2250/2132; A23V 2002/00

(57) ABSTRACT

The present invention provides food grade sugar particles comprising sucrose crystals, reducing sugars and polyphenols, wherein the sugar composition comprises about 0 to 0.15 g/100 g reducing sugars and about 20 mg/100 g to about 45 mg/100 g polyphenols and the sugar particles have a glucose based glycaemic index of less than 55.

### FIELD OF THE INVENTION

The present invention relates to sugar compositions and processes for the preparation of sugar. In particular, the present invention relates to sugar with a low glycaemic index (GI) and processes for the preparation of low GI sugar.

### BACKGROUND OF THE INVENTION

There is concern that refined white sugar is causal in the development of diabetes and obesity. There is strong demand for a healthier sugar product. There is also demand for less refined (ie more natural) sugar products.

Refined white sugar has been prepared by substantially similar processes for a long time. Following harvest, sugar cane is shredded and crushed to create sugar juice. The juice is clarified and heated under vacuum to concentrate it by evaporation. The resulting syrup can crystallise as it thickens or be seeded to produce sugar crystals. Molasses is the viscous syrup that remains after crystallisation. The molasses is removed to leave a dense suspension of sugar crystals in the remaining syrup that is called massecuite. The massecuite is washed in a centrifuge, refined and then dried to produce bulk white sugar. This bulk white sugar is refined at a refinery to produce food grade refined white sugar, which is generally 99.5% sucrose with an average crystal size of 0.6 mm. Castor sugar has an average crystal size of 0.3 mm and icing sugar is produced by crushing white sugar in a special mill to produce a fine powder.

The refining process used to prepare refined white sugar removes most vitamins, minerals and phytochemical compounds from the sugar leaving a “hollow nutrient”, that is, a food without significant nutritional value.

Non-white sugars include brown sugar, in which molasses may be sprayed back onto refined white sugar. Brown sugar has a rich taste but may have a higher GI than white sugar because of the glucose content in the molasses. “Raw sugar” is the name given to light brown sugar. Raw sugar, like white sugar is traditionally medium GI. Raw sugar can be prepared by spraying white refined sugar with molasses or an extract of a sugar production by-product containing phytochemicals or by preparing a “less refined” sugar ie one that was never refined to white. When white refined sugar is sprayed with molasses both phytochemical content and reducing sugar content are increased because molasses is high in the reducing sugars glucose and fructose. This makes the sugar hygroscopic, higher GI and more expensive than white refined sugar. Less refined sugars also tend to be hygroscopic and have significant problems with variability. The GI of these sugars is likewise variable.

Nevertheless, retention of vitamins, minerals and phytochemicals in sugar has been demonstrated to improve health and lower glycaemic index (GI) in some circumstances (see Jaffe', W. R., Sugar Tech (2012) 14:87-94). This is useful because it is thought that individuals who are susceptible to type II diabetes and coronary heart disease should follow a low GI diet. It has also been found that following a low GI diet can assist individuals with diabetes to manage their sugar levels and it can assist individuals with obesity problems to control food cravings, reduce appetite swings and improve eating habits. One example of developments in low GI foods is disclosed in international patent publication no WO 2004014159, which described administering an effective amount of flavonoids to inhibit the action of enzymes, such as α-amylase, which break down carbohydrate in the intestine, thereby inhibiting the rate at which glucose is released into the bloodstream.

The glycaemic index is a system for classifying carbohydrate-containing foods according to how fast they raise blood-glucose levels inside the body. A higher GI means a food increases blood-glucose levels faster. The GI scale is from 1 to 100. The most commonly used version of the scale is based on glucose. 100 on the glucose GI scale is the increase in blood-glucose levels caused by consuming 50 grams of glucose. High GI products have a GI of 70 or more. Medium GI products have a GI of 55 to 69. Low GI products have a GI of 54 or less. These are foods that cause slow rises in blood-sugar. High GI foods trigger strong insulin responses. Frequently repeated strong insulin responses are thought to, over time, result in an increased risk of diabetes. Low GI foods do not trigger an insulin response.

Low GI raw sugars have now been produced by spraying specific sugar extracts onto refined white sugar or primary mill sugar (ie: sugar after centrifugal washing but before refining at a refinery).

However, low GI sugar is not commonly used in industry in the preparation of foods containing sugar. The vast majority of the sugar used as an ingredient in industry is refined white sugar. The use of low GI raw sugar by the food industry is likely to increase if sugar of that type could be produced at lower cost and/or with low hygroscopicity.

Low hygroscopicity is important because hygroscopicity makes the sugar difficult to use and store. This is particularly, disadvantageous in an industrial setting because of the tendency for the sugar to clump and stick to equipment. Working with hygroscopic sugar in an industrial setting may require, for example, equipment operating under nitrogen to minimise the quantity of sugar that clumps or sticks to the equipment. While hygroscopic low GI raw sugars are sold as retail products they are not ideal for industrial use in the preparation of other foods, such as, chocolate, beverages, cereals, confectionary, bakery goods and other retail foods containing sugar.

Adding molasses or other sugar extracts back onto refined white sugar also can involve adding colourants and minerals, which are chelated in the sugar cane, back onto the refined sugar in a context where there is no chelation. Free and unchelated polyphenols can act in the body to remove dietary minerals (in particular calcium) and increase the risk of osteoporosis. Mice fed a molasses extract have been shown to lose body weight and increase muscle mass but also lose significant bone mineral content. Consequently, the molasses sprayed back on to create the raw or brown sugar needs to address this issue, for example, by addition of chelators, such as minerals.

Replacing white sugar with less expensive low GI raw sugar in high use products such as confectionary eg chocolate is likely to reduce health risks and enable the growth of a more competitive and sustainable sugar-manufacturing sector. This has not yet been possible because less refined sugars are typically variable in their specifications and the quantity of health promoting phytochemicals is not standardised. In addition, raw sugars with nutrient returned by spraying molasses onto refined white sugar tend to be hygroscopic, high GI and/or too expensive to be a viable replacement for refined white sugar.

There is a need for an inexpensive, non-hygroscopic, low GI raw sugar that can be prepared at a low cost and to consistent specification in large quantities. A sugar that improves upon any one of these characteristics is a useful advance for the sugar industry.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

The inventors of the present invention have developed a less refined raw sugar or a ‘real’ raw sugar with low hygroscopicity that allows industrial use without the need to have equipment operated under nitrogen. The raw sugar is considered a raw sugar because it is a light brown sugar. However, it is not prepared by spraying molasses or another sugar extract onto refined white sugar. Instead, the raw sugar is prepared without ever forming white sugar. Therefore, it is a less refined sugar or ‘real’ raw sugar. One advantage of preparing a less refined sugar that is suitable for industrial use is that less processing is required so the sugar is prepared economically and likely to provide cost benefits to industry.

It is also beneficial that some of the vitamins, minerals and phytochemical compounds naturally in the sugar are retained so the sugar retains nutritional value and is not a “hollow nutrient”. Another advantage of preparing a less refined low GI sugar is that the natural colourants and minerals are not removed from their natural chelators. Without being bound by theory, it is thought that retaining the phytochemicals such as polyphenols in their natural context (ie with minerals and fibres) rather than removing them to produce refined white sugar and then adding them back in the form of a molasses extract will avoid problems with loss of bone density and will avoid the need for addition of chelators to the sugar because the phytochemicals remain chelated as they are in their natural context.

Once it was identified that a less refined sugar with low GI and low hygroscopicity was desirable, a sugar with those features still needed to be made. Massecuite has high polyphenol, mineral and polysaccharide content but also high reducing sugars (eg glucose and fructose) resulting in high GI and high hygroscopicity. Traditionally massecuite is washed all the way to white sugar crystals. Refined white sugar has negligible polyphenol content and low reducing sugar resulting in a medium GI driven by the sucrose content and low hygroscopicity. The inventor of the present invention has identified a “sweet spot” in the level of sugar processing (ie the amount the massecuite is washed) where sugar particles are produced with desirable features. As the massecuite is washed to produce sugar particles, both the polyphenol content and reducing sugar content lower. The inventor of the present invention has identified that there is a specific point in the wash where: 1. the reducing sugar content is low enough that the sugar is low hygroscopicity and the reducing sugars are not raising the GI of the sucrose and 2. the polyphenol content remains high enough to lower the GI of the sucrose. Understanding this sweet spot has allowed preparation of novel sugar particles. While preparation of a less refined sugar with the features of the novel sugar particles is efficient, it is not the only way to prepare a sugar with these features. It is also possible, for example, to add extracts to more refined sugars to achieve the features of the novel sugar.

In one aspect, the present invention provides food grade sugar particles comprising sucrose crystals, reducing sugars and polyphenols, wherein the sugar particles comprise about 0 to 0.5 g/100 g reducing sugars and about 20 mg/100 g to about 45 mg/100 g polyphenols and the sugar particles have a glucose based glycaemic index of less than 55.

In another aspect, the present invention provides food grade sugar particles comprising sucrose crystals, reducing sugars and polyphenols, wherein the sugar particles comprise about 0 to 0.5 g/100 g reducing sugars and about 20 mg/100 g to about 45 mg/100 g polyphenols and wherein a first proportion of the polyphenols are entrained within the sucrose crystals and a second proportion of the polyphenols is distributed on the surfaces of the sucrose crystals. Referring to a first proportion and a second proportion of polyphenols does not imply that these proportions have a different source; in fact, in preferred embodiments the polyphenols in the first proportion and the second proportion are those originally in the massecuite. The amount of polyphenols is efficacious for achieving a low GI (as defined below) in a sugar particle with low reducing sugar content described elsewhere. As indicated in Example 2, polyphenol content is expressed in terms of its milligrams catechin equivalents (mg CE) per 100 g of total sugar.

It is also preferred that the sugar has low hygroscopicity. Low hygroscopicity is useful for industrial processing. If a sugar is too hygroscopic, it is difficult to use that sugar industrially in the production of foods and beverages. Without being bound by theory, it is thought that sugar particles of the invention have lower hygroscopicity than previous low GI sugars because they have lower reducing sugar content.

The sucrose crystals in the sugar particles of the invention are different to the sucrose crystals in sugars produced by adding eg molasses that contains polyphenols onto refined white sugar particles. As described in more detail below, the colour of the sugar particles of the invention is proportionate to the polyphenol content. Sugar contains both coloured and colourless polyphenols. Without being bound by theory, it is thought that, as the total polyphenol content is proportionate to the colour, the coloured and colourless polyphenols are washed from the massecuite at approximately the same rate. Consequently, a refined white sugar prepared by washing from massecuite will not have significant amounts of polyphenols or significant quantities of polyphenols within the sucrose crystals. When the polyphenols (including coloured polyphenols) are added to, for example sprayed onto, colourless refined sugar particles the sucrose crystals in those particles do not dissolve. Therefore, in those sugars any polyphenol content in the sucrose crystals is insignificant and the coloured polyphenols sit on the surface of, not within, the sucrose crystals.

In an alternate aspect, the present invention provides food grade sugar particles comprising sucrose crystals, reducing sugars and polyphenols, wherein the sugar particles comprise about 0 to 0.5 g/100 g reducing sugars and about 20 mg CE/100 g to about 45 mg CE/100 g polyphenols and wherein the polyphenols in the sugar are endogenous and have never been separated from the sucrose crystals. Preferably, a first proportion of the polyphenols are entrained within the sucrose crystals and a second proportion of the polyphenols is distributed on the surfaces of the sucrose crystals. This is important because it distinguishes prior sugar products where polyphenols are separated from the sucrose crystals and later sprayed back on to the sucrose crystals. This more natural process optionally has several advantages including one or more of increased efficiency, sugar particles with lower reducing sugar content and thus lower hygroscopicity, release of nutrients over the entire period in which the sugar is dissolved, and/or minimising the problems associated with unchelated polyphenols in prior sugars.

In some embodiments, the sugar particles contain an amount of polyphenols that is less than the amount of polyphenols in an equivalent quantity of the massecuite from which the sugar particles were prepared. In alternate embodiments, the sugar particles contain both an amount of polyphenols and an amount of reducing sugars that is less than the amount of polyphenols and amount of reducing sugars in an equivalent quantity of the massecuite from which the sugar particles were prepared.

In some embodiments, the sugar particles are produced from massecuite comprising polyphenols; an amount of the polyphenols in the massecuite are removed during processing of the massecuite; and the first proportion and second proportion of the polyphenols remain in the sugar particles after processing of the massecuite. In particular, the amount of the polyphenols in the massecuite removed during processing of the massecuite are removed because the massecuite was washed and the second proportion of polyphenols remain on the surface of the sucrose crystals because washing of the massecuite was ceased before removal of all of the polyphenols from the surfaces of the sucrose crystals. Preferably, the first proportion and second proportion of polyphenols amount to about 20 mg CE/100 g to about 45 mg CE/100 g polyphenols and no other polyphenols are present. Alternatively, the first proportion and second proportion of polyphenols amounts to less than 20 mg CE/100 g to about 45 mg CE/100 g polyphenols and a third portion of polyphenols is added to the sugar particles to reach the desired polyphenol content. Optionally, where a third proportion of polyphenols is added to the sugar particles, that third proportion is less than 50%, 40%, 30%, 20%, 10% of the polyphenol content.

The low reducing sugar content of 0 to 0.5 g/100 g means the sugar particles can be handled by industrial equipment in an unaltered atmosphere (ie not under nitrogen) without significant clumping or sticking to the equipment. Alternatively, the reducing sugar content is about 0 to about 0.35 g/100 g, about 0 to about 0.2 g/100 g, about 0.001 g/100 g to about 0.15 g/100 g, about 0.001 g/100 g to about 0.1 g/100 g, about 0.01 g/100 g to 0.1 g/100 g or about 0.01 g/100 g to 0.08 g/100 g. Optionally, the reducing sugars are glucose and fructose. Optionally, the glucose to fructose ratio is 0.8 to 1.2.

In some embodiments of the present invention, the reducing sugar is 0.001% to 1%, 0.001% to 0.5%, 0.001% to 0.2%, 0.001% to 0.15%, 0.001% to 0.1%, 0.01 to 0.1%, 0.05% to 0.1%, 0.1% to 0.4%, 0 1% to 0.3% or 0.01% to 0.08% of the total sugar in the sugar particles.

Alternatively, the reducing sugar content of the sugar particles is 0 to 0.2% w/w, 0.1% to 0.2% w/vv or 0.12% to 0.16% vv/w.

In some embodiments of the present invention, the sugar particles are about 98 to about 99.5% w/w, about 98.5 to about 99.5% w/w or about 98.8 to about 99.2% w/w sucrose.

In some embodiments, the sugar particles of the present invention have moisture content of 0.02% to 0.6%, 0.02 to 0.3% 0.02% to 0.2%, 0.1% to 0.5%, 0.1% to 0.4%, 0.1 to 0.2%, 0.2% to 0.3% or 0.3 to 0.4% w/w of the sugar particles. Preferred moisture content is 0.13% to 0.17%. Alternatively, the loss of moisture in the sugar particles when the sugar particles are dried following their manufacture is a maximum of 0.3%. This moisture content can be achieved by usual drying of sugar particles following the washing of the massecuite as described below.

It is preferred that the sugar particles have moisture content as described above when they are manufactured and have 0.02% to 1%, 0.02% to 0.8%, 0.02% to 0.6%, 0.1% to 0.5%, 0.1% to 0.4% or 0.2% to 0.3% w/w moisture content after 6 months storage at room temperature and 40% relative humidity or, alternatively, after 12 months storage at room temperature and 40% relative humidity. Alternatively, the increase in moisture content of the sugar particles is a maximum of 0.3% over the shelf life for the sugar particles. Preferably, the shelf life of the sugar particles is 2 years. The sugar particles of the invention retain the above low moisture content after storage because they are less hygroscopic than the previous low GI sugars. Without being bound by theory, the lower hygroscopicity is thought to be a result of the low reducing sugar content of the sugar particles of the invention.

The phytochemicals in the sugar particles of the invention include polyphenols. The polyphenols preferably include flavonoids. Preferably, the polyphenols include tricin, luteolin and/or apigenin. Alternatively, the polyphenols include tricin, In some embodiments of the invention the amount of polyphenols in the sugar particles is about 20 mg/100 g to about 45 mg/100 g, about 20 mg/100 g to about 40 mg/100 g, about 20 mg/100 g to about 35 mg/100 g, about 22 mg/100 g to about 32 mg/100 g, about 25 mg/100 g to about 35 mg/100 g, about 25 mg/100 g to about 30 mg/100 g or about 26 mg/100 g to about 28 mg/100 g. In preferred embodiments of the invention, the polyphenol content is 25 mg/100 g to about 35 mg/100 g. As indicated in Example 2, polyphenol content is expressed in terms of its milligrams catechin equivalents per 100 g of total sugar.

In some embodiments of the present invention, the sugar particles (ie the food grade completely processed sugar particles) have about 50% to 95% of the polyphenols on the outside of the sugar particles and about 5% to 50% of the polyphenols within the sucrose crystals. Alternatively, about 60% to 85% of the polyphenols are on the outside of the sugar particles and about 15% to 40% of the polyphenols are within the sucrose crystals, about 65% to 80% of the polyphenols are on the outside of the sugar particles and about 20% to 45% of the polyphenols are the sucrose crystals. In particular, about 70% to 75% of the polyphenols are on the outside of the sugar particles and about 25% to 30% of the polyphenols are within the sucrose crystals.

The sugar particles of the present invention preferably have a low glycaemic index. In particular, the sugar particles of the invention have a glucose based glycaemic index of less than 55. Preferably, the glucose based glycaemic index is from about 10 to about 55, from about 20 to about 55, from about 30 to about 55, from about 40 to about 55, from about 40 to 50, from about 45 to about 55, from about 47 to about 53 or from about 50 to about 55. In preferred embodiments of the invention, the glucose based glycaemic index of the sugar particles is about 50.

In another aspect, the present invention provides low GI food grade sugar particles comprising sucrose crystals, reducing sugars and polyphenols, wherein the amount of polyphenols is effective to lower the glucose based glycaemic index to less than 55 and the reducing sugars are 0.2% or less of the total sugar in the sugar particles.

In some embodiments of the present invention, the sugar particles have a colour of about 500 to 2000 ICUMSA, about 750 to 1800 ICUMSA or about 1000 to 1500 ICUMSA. The ICUMSA of the sugar particles is therefore related to the polyphenol content of the sugar particles (see Example 7 and FIG. 6).

In some embodiments of the present invention, the sugar particles have an electrical conductivity of 100 to 300 microSiemens per centimetre (pS/cm) or 150 to 250 pS/cm. The conductivity of the sugar particles is related to the polyphenol content of the sugar particles (see example 7 and FIG. 5).

In some embodiments of the present invention, the sugar particles comprise the following minerals 25-115 mg/kg sodium (Na), 330-670 mg/kg potassium (K), 135-410 mg/kg calcium (Ca), 25-70 mg/kg magnesium (Mg), 11-52 mg/kg iron (Fe), 12-35 phosphate (PO₄), 530-885 sulfate (SO₄), 75-185 chlorine (Cl), one or more of these or all of these. Optionally, the sugar particles comprise all of the above minerals.

In some embodiments of the present invention, the sugar particles comprise an antioxidant activity of 5 mg GAE/100 g to 25 mg GAE/100 g.

In some embodiments of the present invention, the sugar particles will fall within the maximum residue limits for chemicals set out in Schedule 20 of the Australian Food Standards Code in force July 2017. Optionally, the sugar particles meet the following pesticide/herbicide levels: less than 5 mg/kg 2,4-dichlorophenoxyacetic acid, less than 0.05 mg/kg paraquat, less than 0.05 mg/kg ametryn, less than 0.1 mg/kg atrazine, less than 0.02 mg/kg diuron, less than 0.1 mg/kg hexazinone, less than 0.02 mg/kg tebuthiuron, less than 0.03 mg/kg glyphosate, a combination of these or all of these.

Alternatively, the sugar particles fall within the following pesticide/herbicide levels: less than 0.005 mg/kg 2,4-dichlorophenoxyacetic acid, less than 0.01 mg/kg diquat, less than 0.01 mg/kg paraquat, less than 0.01 mg/kg ametryn, less than 0.01 mg/kg atrazine, less than 0.05 mg/kg bromacil, less than 0.01 mg/kg diuron, less than 0.05 mg/kg hexazinone, less than 0.01 mg/kg simazine, less than 0.01 mg/kg tebuthiuron, less than 0.01 mg/kg glyphosate, a combination of these or all of these.

It is preferred that the sugar particles of the various aspects of the invention are produced from massecuite. The massecuite contains polyphenols. A proportion of the polyphenols in the massecuite are entrained within the sucrose crystals in the massecuite. Massecuite also contains a proportion of polyphenols that are not entrained in the sucrose crystals and the proportion of polyphenols not entrained in the sucrose crystals is generally significantly greater than the proportion of polyphenols entrained within the sucrose crystals. The exact proportions can vary considerably based on variations in the process used to prepare the massecuite and variations in the sugar cane from which the massecuite is prepared. As an example, the quantity of polyphenols not entrained within the sucrose crystals could be tens to hundreds of times more than the amount of polyphenols entrained within the sucrose crystals. It is preferred that the polyphenols entrained in the sucrose crystals in the massecuite are retained during processing of the massecuite and remain in the sugar particles. It is also preferred that an amount of the polyphenols not entrained within the sucrose crystals is retained during processing of the massecuite and remains on the surface of the sugar particles. In other words, it is preferred that the polyphenols in the sugar particles are endogenous to the sugar cane from which the sugar particles are prepared. It is also preferred that the endogenous polyphenols are not separated from and then reintroduced to the sugar particles but remain with the bulk sucrose from which the sugar particles are seeded throughout processing and remain with the sugar particles through the washing process that follows seeding. Alternatively, the polyphenols are retained during processing of the massecuite and remain in the sugar composition because washing of the massecuite was ceased before removal of all of the polyphenols. A consequence of this process is that polyphenols entrained within the sucrose crystals remain within the sucrose crystals from the formation of those crystals and continue to remain within the sucrose crystals within the finished product. It is preferred that the polyphenols remain in the sugar particles because washing of the massecuite was ceased before removal of all the polyphenols from the sugar particles (ie washing was ceased before the sugar particles became white). Preferably, washing is ceased when the sugar particles contain the desired quantity of polyphenols. In most preferred embodiments, washing massecuite is ceased when the sugar particles retain the desired level of polyphenols (ie 20 mg CE/100 g to 45 mg CE/100 g) and the sugar particles retain the desired level of reducing sugars (ie 0 to 0.1 mg/100 g reducing sugar content). Consequently, both of the benefits of the less refined sugar of the present invention, ie efficacious polyphenol levels and a low reducing sugar content, can be achieved by simply ceasing massecuite washing at the appropriate time. Achieving both outcomes with a single processing step is very efficient making the sugar particles of the present invention low cost.

In one aspect, the present invention provides a method for preparing sugar particles comprising washing massecuite to produce sugar particles, wherein the massecuite includes sucrose crystals, polyphenols and reducing sugars, wherein the wash removes an amount of polyphenols and an amount of reducing sugars from the massecuite, wherein the sugar particles comprise about 0 to 0.5 g/100 g reducing sugars and about 20 mg/100 g to about 45 mg/100 g polyphenols and wherein the sugar particles have a glucose based glycaemic index of less than 55. Other features of the method and the resulting sugar particles are as described above. Optionally, the wash is ceased when the sugar particles comprise 0 to 0.5 g/100 g reducing sugars and less than about 45 mg CE/100 g polyphenols and additional polyphenols are added to the sugar particles to prepare sugar comprising about 20 mg CE/100 g to about 45 mg CE/100 g polyphenols. Optionally, the wash is ceased when the sugar particles comprise 0 to 0.5 g/100 g reducing sugars and about 20 mg/100 g to about 45 mg/100 g polyphenols and no polyphenols or reducing sugars are either added to or removed from the sugar particles following the wash.

In another aspect, the present invention provides a method for preparing sugar particles comprising preparing massecuite from sugar cane, washing the massecuite and collecting the sugar particles remaining after washing the massecuite, wherein the massecuite includes sucrose crystals, polyphenols and reducing sugars, wherein a proportion of the polyphenols are entrained within the sucrose crystals, wherein the sugar particles comprise about 0 to 0.5 g/100 g reducing sugars and about 20 mg CE/100 g to about 45 mg CE/100 g polyphenols. Other features of the method and the resulting sugar particles are as described above.

In an alternative aspect, the present invention provides a method for preparing sugar particles comprising preparing massecuite from sugar cane, washing the massecuite and collecting the sugar particles remaining after washing the massecuite, wherein the massecuite includes sucrose crystals, polyphenols and reducing sugars, wherein a proportion of the polyphenols are entrained within the sucrose crystals, wherein the sugar particles after washing the massecuite comprise about 0 to 0.5 g/100 g reducing sugars and about 5 mg CE/100 g to about 20 mg CE/100 g polyphenols and further polyphenols are added so that the sugar particles comprise about 20 mg CE/100 g to 45 mg CE/100 g polyphenols. Other features of the method and the resulting sugar particles are as described above.

In an alternative aspect, the present invention provides a method for preparing sugar particles comprising preparing massecuite from sugar cane, washing the massecuite and collecting the sugar particles remaining after washing the massecuite, wherein the massecuite includes sucrose crystals, polyphenols and reducing sugars, wherein the sugar particles comprise about 0 to 0.5 g/100 g reducing sugars and about 20 mg CE/100 g to about 45 mg CE/100 g polyphenols, wherein the polyphenols remaining in the sugar particles were in the massecuite and were not removed by the washing. In other words, the method retains polyphenols from the massecuite in the sucrose crystals that are collected after the washing process. The polyphenol containing sucrose crystals directly result from the massecuite following removal of some of the polyphenol content, some reducing sugar content and pesticides/herbicides by washing the massecuite such that the same massecuite is the source of the sugar and polyphenols. Other features of the method and the resulting sugar particles are as described above.

In a further alternative aspect, the present invention provides a method for preparing sugar particles comprising preparing massecuite from sugar cane, washing the massecuite and collecting the sugar particles remaining after washing the massecuite, wherein the massecuite includes sucrose crystals, polyphenols and reducing sugars, wherein the sugar particles after washing the massecuite comprise about 0 to 0.5 g/100 g reducing sugars and about 5 mg CE/100 g to about 20 mg CE/100 g polyphenols that were in the massecuite and were not removed by the washing, wherein further polyphenols were added to prepare sugar particles comprising 20 mg CE/100 g to 45 mg CE/100 g polyphenols. In other words, the method retains polyphenols from the massecuite in the sucrose crystals that are collected after the washing process. The polyphenol containing sucrose crystals directly result from the massecuite following removal of some of the polyphenol content, some reducing sugar content and pesticides/herbicides by washing the massecuite such that the same massecuite is the source of the sugar and polyphenols in the sugar particles after the washing then further polyphenols are added, if further polyphenols are needed to achieve an amount effective for a low GI. Other features of the method and the resulting sugar particles are as described above.

In some embodiments of the invention, the massecuite has 200-400 mg CE/100 g polyphenols. In preferred embodiments, the massecuite has 240-320 mg CE/100 g.

In some embodiments of the invention, washing the massecuite removes 165-380 mg CE/100 g polyphenols. In preferred embodiments, washing the massecuite removes 220-300 mg CE/100 g polyphenols.

In some embodiments of the invention, the washing of the massecuite removes the herbicides and/or pesticides that can be present in massecuite resulting in sugar particles that fall within the maximum residue limits for chemicals set out in Schedule 20 of the Australian Food Standards Code in force July 2017. Optionally, the washing of the massecuite removes the herbicides and/or pesticides that can be present in massecuite resulting in sugar particles that meet the following pesticide/herbicide levels: less than 5 mg/kg 2,4-dichlorophenoxyacetic acid, less than 0.05 mg/kg paraquat, less than 0.05 mg/kg ametryn, less than 0.1 mg/kg atrazine, less than 0.02 mg/kg diuron, less than 0.1 mg/kg hexazinone, less than 0.02 mg/kg tebuthiuron, less than 0.03 mg/kg glyphosate, a combination of these or all of these.

Alternatively, the washing of the massecuite removes the herbicides and/or pesticides that can be present in massecuite resulting in sugar particles that meet the following pesticide/herbicide levels: less than 0.005 mg/kg 2,4-dichlorophenoxyacetic acid, less than 0.01 mg/kg diquat, less than 0.01 mg/kg paraquat, less than 0.01 mg/kg ametryn, less than 0.01 mg/kg atrazine, less than 0.05 mg/kg bromacil, less than 0.01 mg/kg diuron, less than 0.05 mg/kg hexazinone, less than 0.01 mg/kg simazine, less than 0.01 mg/kg tebuthiuron, less than 0.01 mg/kg glyphosate, a combination of these or all of these.

One advantage of the present invention is that the phytochemicals in the sugar particles are in their endogenous context and have not been separated from their endogenous chelation. Therefore, the sugar particles of the present invention preferably do not require the addition of chelators.

The present invention has a number of specific forms. Additional embodiments are of these forms are as discussed elsewhere in the specification. In one form, the present invention provides food grade sugar particles comprising sucrose crystals, reducing sugars and polyphenols, wherein the sugar particles comprise about 0 to 0.5 g/100 g reducing sugars, about 20 mg CE/100 g to about 45 mg CE/100 g polyphenols, and moisture content of 0.02% to 0.6%, wherein the sugar particles have a glucose based glycaemic index of less than 55 and wherein the polyphenols in the sugar are endogenous and have never been separated from the sugar.

In an alternate embodiment, the present invention provides food grade sugar particles comprising sucrose crystals, reducing sugars, polyphenols and moisture, wherein the sugar particles comprise about 98 to 99.5% sucrose, 0 to 0.5 g/100 g reducing sugars, about 20 mg/100 g to about 45 mg/100 g polyphenols, about 0.1 to 0.2% w/w moisture and the sugar has glucose based glycaemic index of less than 55.

In an alternate embodiment, the present invention provides food grade sugar particles comprising sucrose crystals, reducing sugars and polyphenols, wherein the sugar particles comprise about 0 to 0.5 g/100 g reducing sugars and about 20 mg CE/100 g to about 45 mg CE/100 g polyphenols, wherein a first proportion of the polyphenols are entrained within the sucrose crystals and a second proportion of the polyphenols is distributed on the surfaces of the sucrose crystals, wherein the sugar particles have a glucose based glycaemic index of less than 55 and wherein the sugar particles have low hygroscopicity (ie attract minimal water such that they can be used industrially in the preparation of other foods and beverages).

In an alternate embodiment, the present invention provides food grade sugar particles comprising sucrose crystals, reducing sugars and polyphenols, wherein the sugar particles comprise about 0 to 0.5 g/100 g reducing sugars and about 20 mg CE/100 g to about 45 mg CE/100 g polyphenols, wherein a first proportion of the polyphenols are entrained within the sucrose crystals and a second proportion of the polyphenols is distributed on the surfaces of the sucrose crystals, wherein the sugar particles have a glucose based glycaemic index of less than 55 and wherein the moisture content of the sugar particles is 0.02% to 1% after 6 months or 12 months storage at room temperature and 40% relative humidity.

In an alternate embodiment, the present invention provides food grade sugar particles comprising sucrose crystals, reducing sugars and polyphenols, wherein the sugar particles comprise about 0 to 0.5 g/100 g reducing sugars and about 20 mg CE/100 g to about 45 mg CE/100 g polyphenols, wherein a first proportion of the polyphenols are entrained within the sucrose crystals and a second proportion of the polyphenols is distributed on the surfaces of the sucrose crystals, wherein the sugar particles have a glucose based glycaemic index of less than 55 and wherein the moisture content of the sugar particles increases by a maximum of 0.3% over 2 years.

In an alternate embodiment, the present invention provides food grade sugar particles comprising sucrose crystals, reducing sugars and polyphenols, wherein the sugar particles comprise about 0 to 0.5 g/100 g reducing sugars and about 20 mg CE/100 g to about 45 mg CE/100 g polyphenols, wherein a first proportion of the polyphenols are entrained within the sucrose crystals and a second proportion of the polyphenols is distributed on the surfaces of the sucrose crystals, wherein the sugar particles have a glucose based glycaemic index of less than 55, wherein the sugar particles are non-hygroscopic and wherein the sugar particles fall within the maximum residue limits for chemicals set out in Schedule 20 of the Australian Food Standards Code in force July 2017.

In an alternate embodiment, the present invention provides food grade sugar particles comprising sucrose crystals, reducing sugars and polyphenols, wherein the sugar particles comprise about 0.1% to 0.2% reducing sugars and about 25 mg CE/100 g to about 35 mg CE/100 g polyphenols, wherein a first proportion of the polyphenols are entrained within the sucrose crystals and a second proportion of the polyphenols is distributed on the surfaces of the sucrose crystals, wherein the sugar particles have a glucose based glycaemic index of less than 55 and wherein the sugar particles have low hygroscopicity.

In an alternate embodiment, the present invention provides food grade sugar particles comprising sucrose crystals, reducing sugars, polyphenols and moisture, wherein the sugar particles comprise about 98.8 to 99.2% sucrose, 0.13 to 0.17% w/w reducing sugars, about 25 mg/100 g to about 35 mg/100 g polyphenols, about 0.13 to 0.17% w/w moisture and the sugar has glucose based glycaemic index of less than 55.

In an alternate embodiment, the present invention provides a method for preparing sugar particles comprising preparing massecuite from sugar cane, washing the massecuite and collecting the sugar particles remaining after washing the massecuite, wherein the massecuite includes sucrose crystals, polyphenols and reducing sugars, wherein a proportion of the polyphenols are entrained within the sucrose crystals, wherein the sugar particles comprise about 0 to 0.5 g/100 g reducing sugars and about 20 mg CE/100 g to about 45 mg CE/100 g polyphenols, wherein the sugar particles have a glucose based glycaemic index of less than 55 and wherein the sugar particles have low hygroscopicity.

In an alternate embodiment, the present invention provides a method for preparing sugar particles comprising preparing massecuite from sugar cane, washing the massecuite and collecting the sugar particles remaining after washing the massecuite, wherein the massecuite includes sucrose crystals, polyphenols and reducing sugars, wherein a proportion of the polyphenols are entrained within the sucrose crystals, wherein the sugar particles comprise about 0 to 0.5 g/100 g reducing sugars and about 20 mg CE/100 g to about 45 mg CE/100 g polyphenols, wherein the sugar particles have a glucose based glycaemic index of less than 55, wherein the sugar particles have low hygroscopicity, wherein the massecuite comprises 200-400 mg CE/100 g polyphenols and wherein washing the massecuite removes 165-380 mg CE/100 g polyphenols. Optionally, the washing also results in sugar particles that fall within the maximum residue limits for chemicals set out in Schedule 20 of the Australian Food Standards Code in force July 2017.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

It will be understood that the invention disclosed and defined in this specification extends to all alternative combinations of two or more of the individual features mentioned or evident from the text or drawings. All of these different combinations constitute various alternative aspects of the invention.

### BRIEF DESCRIPTION OF THE DRAWINGS

FIG. 1 shows a graph of Cl v polyphenol content in mg CE/100 g of sucrose sugars prepared by washing massecuite to various polyphenol contents. This figure shows sugars have low GI at about 22-32 mg CE/100 g polyphenols.

FIG. 2 graphs moisture (% w/w or mg/100 g), glucose (% w/w or mg/100 g) and fructose (% w/w or mg/100 g) content each separately against polyphenol content in sucrose sugars prepared by washing massecuite to various polyphenol contents. This figure shows that GI increases in sugars with polyphenol content above 32 mg CE/100 g (ie more polyphenols is not better). Without being bound by theory, it is thought that the increase in polyphenol content itself does not increase the GI of the sugar. As the polyphenol content of the sugar increases above about 22-32 mg CE/100 g polyphenols, the reducing sugar content of the sugar also increases and the sugar becomes hygroscopic so moisture content increases. The higher GI of the reducing sugars is then thought to overpower the GI lowering polyphenols and raise the GI of the sugar as a whole.

FIG. 3 graphs glucose (% w/w or mg/100 g) and fructose (% w/w or mg/100 g) content against polyphenol content in mg CE/100 g for sucrose sugars prepared by washing massecuite to various polyphenol contents. This figure also shows that GI and reducing sugar content increases in sugars with polyphenol content above 32 mg CE/100 g.

FIG. 4 graphs the sucrose content (% w/w or mg/100 g) and moisture levels (% w/w) against polyphenol content in mg CE/100 g for sucrose sugars prepared by washing massecuite to various polyphenol contents.

FIG. 5 graphs the polyphenol content in mg CE/100 g versus the conductivity in μS/cm of sucrose sugars prepared by washing massecuite to various polyphenol contents. The results show a linear relationship between polyphenol content and conductivity.

FIG. 6 graphs similar results to FIG. 5 but the graph is limited to a narrower range of polyphenol content.

FIG. 7 graphs the polyphenol content in mg CE/100 g versus the colour of the sugar in ICUMSA of sucrose sugars prepared by washing massecuite to various polyphenol contents. The results show a linear relationship between polyphenol content and ICUMSA.

FIG. 8 graphs similar results to FIG. 7 but the graph is limited to a narrower range of polyphenol content.

FIG. 9 graphs the polyphenol content in mg CE/100 g versus the antioxidant activity (mg GAE/100 g) of sucrose sugars prepared by washing massecuite to various polyphenol contents.

### DETAILED DESCRIPTION OF THE EMBODIMENTS

Reference will now be made in detail to certain embodiments of the invention. While the invention will be described in conjunction with the embodiments, it will be understood that the intention is not to limit the invention to those embodiments. On the contrary, the invention is intended to cover all alternatives, modifications, and equivalents, which may be included within the scope of the present invention as defined by the claims.

Further aspects of the present invention and further embodiments of the aspects described in the preceding paragraphs will become apparent from the following description, given by way of example.

All of the patents and publications referred to herein are incorporated by reference in their entirety.

For purposes of interpreting this specification, terms used in the singular will also include the plural and vice versa.

One skilled in the art will recognize many methods and materials similar or equivalent to those described herein, which could be used in the practice of the present invention. The present invention is in no way limited to the methods and materials described.

The inventors of the present invention have developed a method for preparing less refined sugar that retains an efficacious level of phytochemicals including polyphenols and flavonoids. The method avoids the need to add molasses or some other extract from a side product of sugar preparation back onto white refined sugar. Consequently, the method is a more direct way to achieve the desired phytochemical content. As the method is more efficient, it is expected that sugar produced by the method will be a cheaper version of raw sugar than currently available.

The term “reducing sugar” refers to any sugar that is capable of acting as a reducing agent. Generally, reducing sugars have a free aldehyde or free ketone group. Glucose, galactose, fructose, lactose and maltose are reducing sugars. Sucrose and trehalose are not reducing sugars.

The term “phytochemical” refers generally to biologically active compounds that occur naturally in plants.

The term “polyphenol” refers to chemical compounds that have more than one phenol group. There are many naturally occurring polyphenols and many are phytochemicals. Flavonoids are a class of polyphenols. Polyphenols including flavonoids naturally occur in sugar cane. In the context of the present invention the polyphenols that naturally occur in sugar cane are most relevant. Polyphenols in food are micronutrients that are of interest because of the role they are currently thought to have in prevention of degenerative diseases such as cancer, cardiovascular disease or diabetes.

The term “raw sugar” refers to a food grade sugar of light brown colour.

The term “refined white sugar” refers to fully processed food grade white sugar that is essentially sucrose with minimal reducing sugar content and minimal phytochemicals such as polyphenols or flavonoids.

The term “entrain” or “entrained” refers to incorporating or drawing in. In relation to crystal formation the term refers to incorporating something into the crystal structure or drawing something into the crystal structure. More specifically, in the context of the present invention the term refers to incorporating polyphenols within the sucrose crystals.

The term “molasses” refers to a viscous by-product of sugar preparation, which is separated from the crystalised sugar. The molasses may be separated from the sugar at several stages of sugar processing.

The term “massecuite” refers to a dense suspension of sugar crystals in the mother liquor of sugar syrup. This is the suspension that remains after concentration of the sugar juice into a syrup by evaporation, crystallisation of the sugar and removal of molasses. The massecuite is the product that is washed in a centrifuge to prepare bulk sugar crystals.

The term “endogenous” refers to something originating from within an organism. In the context of the present invention, it refers to something originating from within sugar cane, for example, a phytochemical including monophenol or polyphenol and polysaccharide can be endogenous because the compound originated from within the sugar cane.

The terms “efficacious” or “effective amount” refer to an amount that is biologically effective. In this context, one example is an effective amount of polyphenols in the sugar particles to achieve a low GI sugar. Another example, is an effective lowering of reducing sugar content to achieve minimal hygroscopicity.

The sugar particles of the present invention can be prepared to food grade quality by methods known to skilled person including using equipment that has covers to prevent external contamination of the sugar particles, for example by bird droppings, the use of magnets to remove iron shavings and other metals and other methods used to prepare food grade sugar.

Where sugar particles according to the present invention are prepared by ceasing washing of the massecuite before the desired level of polyphenols are washed off, the sugar particles of the present invention will contain a variety of chemicals endogenous to sugar cane, for example monophenolics and polysaccharides. Where the sugar particles of the present invention are prepared by this method, it is still possible to prepare food grade sugar. When refined white sugar is prepared, the massecuite is washed to white and the white bulk sugar is transported to a refinery for further refining. Sugar particles of the present invention can be prepared to the desired specifications and to food grade without needing to send the sugar to a refinery.

Sugar cane is referred to specifically in this embodiment because sugar beets do not contain the desired levels of polyphenols. Consequently, sugar particles of the present invention cannot be prepared by ceasing washing of sugar beet massecuite at a desired time.

Sugar particles of the present invention may optionally include additives or extracts such as added flavours, for example maple syrup flavour, colours or additives/extracts to produce additional health, taste, colour or nutritional benefits. Methods for including these additives are known to those skilled in the art.

Sugar particles of the invention may optionally be cocrystallised or agglomerated. Methods for performing these processed are known to those skilled in the art.

ICUMSA is a sugar colour grading system. Lower ICUMSA values represent less colour. ICUMSA is measured at 420 nm by a spectrophotometric instrument such as a Metrohm NIRS XDS spectrometer with a ProFoss analysis system. Currently, sugars considered suitable for human consumption, including refined granulated sugar, crystal sugar, and consumable raw sugar (ie brown sugar), have ICUMSA scores of 45-800. Sugars with scores above 800 are currently used for cosmetics or other non-edible purposes, but require further processing to be fit for human consumption. Consequently, the food grade sugars of the invention with ICUMSA of 500 to 2000 ICUMSA, about 750 to 1800 ICUMSA, about 1000 to 1500 ICUMSA are unexpected.

The sugar particles of the present invention may optionally be prepared using the methods and systems described in Australian Provisional Patent Application No 2016902957 filed on 27 Jul. 2016 with the title “Process for sugar production”.

### REFERENCES

Jaffee, W. R., Sugar Tech (2012) 14:87-94

Joint FAO/WHO Report. Carbohydrates in Human Nutrition. FAO Food and Nutrition. Paper 66. Rome: FAO, 1998.

Kim, Dae-Ok, et al (2003) Antioxidant capacity of phenolic phytochemicals from various cultivars of plums. Food Chemistry, 81, 321-26.

Wolever TMS et al. Determination of the glycemic index values of foods: an interlaboratory study. European Journal of Clinical Nutrition 2003;57:475-482.

A copy of each of these is incorporated into this specification by reference.

### EXAMPLES

### Example 1

### Preparation of Sugar Samples for GI Testing

Sugar 1 was prepared at a sugar mill by processing sugar cane to massecuite. The massecuite was washed until it had 22-32 mg/100 g polyphenol content. One method of achieving sugar with 22-32 mg/100 g polyphenol content is to wash the massecuite in batches and wash each batch a different length of time. The polyphenol content of each washed batch can be analysed as set out in Example 2. The batch with the appropriate polyphenol content can then be selected. It will be understood by the person skilled in the art that each time massecuite is prepared its components vary. Therefore, there is no single set of wash conditions, eg time, spin and water flow, that will always result in a sugar with the desired polyphenol content. The appropriate wash time will vary depending on the components in the massecuite that is being washed.

TABLE 1
Sugar samples

| | | Polyphenols | Moisture |
|---|---|---|---|
| Sample | Sugar content | (mg CE/100 g) | (%) |
| Standard | glucose | 0 | — |
| Control sugar | 99.9% sucrose | 0 | 0.075 |
| (refined white | 0% glucose | | |
| sugar) | 0% fructose | | |
| Sugar 1 | 95.2% sucrose | 26.5 | 0.36 |
| | 0.11% glucose | | |
| | 0.09% fructose | | |
| Sugar 2 | 89.5% sucrose | 60.9 | 0.65 |
| | 1.42% glucose | | |
| | 1.55% fructose | | |

### Example 2

### Analysis of Polyphenol Content in Sugar

40 g of sugar sample was accurately weighed into a 100 ml volumetric flask. Approximately 40 ml of distilled water was added and the flask agitated until the sugar was fully dissolved after which the solution was made up to final volume with distilled water. The polyphenol analysis was based on the Folin-Ciocalteu method (Singleton 1965) adapted from the work of Kim et al (2003). In brief, a 50 μL aliquot of appropriately diluted raw sugar solution was added to a test tube followed by 650 μL pf distilled water. A 50 μL aliquot of Folin-Ciocalteu reagent was added to the mixture and shaken. After 5 minutes, 500 μL of 7% Na₂CO₃ solution was added with mixing. The absorbance at 750 nm was recorded after 90 minutes at room temperature. A standard curve was constructed using standard solutions of catechin (0-250 mg/L). Sample results were expressed as milligrams of catechin equivalent (CE) per 100 g raw sugar. The absorbance of each sample sugar was determined and the quantity of polyphenols in that sugar determined from the standard curve.

Where the sugar is a less refined sugar prepared by a limited wash, an alternative method for analysis of the polyphenol content is to measure the amount of tricin in a sample using near-infra red spectroscopy (NIR). In these circumstances, the amount of tricin is proportional to the total polyphenols. Further information on this method is available in Australian Provisional Patent Application No 2016902957 filed on 27 Jul. 2016 with the title “Process for sugar production”.

### Example 3

### Analysis of the Reducing Sugar Content in Sugar

There are several qualitative tests that can be used to determine reducing sugar content in a sugar product. Copper (II) ions in either aqueous sodium citrate or in aqueous sodium tartrate can be reacted with the sugar. The reducing sugars convert the copper(II) to copper(I), which forms a copper(I) oxide precipitate that can be quantified.

An alternative is to react 3,5-dinitrosalicylic acid with the sugar. The reducing sugars will react with this reagent to form 3-amino-5-nitrosalicylic acid. The quantity of 3-amino-5-nitrosalicylic acid can be measured with spectrophotometry and the results used to quantify the amount of reducing sugar present in the sugar product.

### Example 4

### GI Testing

The GI testing was conducted using internationally recognised GI methodology (see the Joint FAO/WHO Report), which has been validated by results obtained from small experimental studies and large multi-centre research trials (see Wolever et al 2003). The experimental procedures used in this study were in accordance with international standards for conducting ethical research with humans approved by the Human Research Ethics Committee of Sydney University.

Experimental Procedures

Using standard methodology to determine a food's GI value, a portion of the food containing between 10 and 50 grams of available carbohydrate is fed to 10 healthy people the morning after they have fasted for 10-12 hours overnight. A fasting blood sample is first obtained from each person and then the food is consumed, after which additional blood samples are obtained at regular intervals during the next two hours. In this way, it's possible to measure the total increase in blood sugar produced by that food over a two-hour period. The two-hour blood glucose (glycaemic) response for this test food is then compared to the two-hour blood glucose response produced by the same amount of carbohydrate in the form of pure glucose sugar (the reference food: GI value of glucose =100%). Therefore, GI values for foods and drinks are relative measures (ie they indicate how high blood sugar levels rise after eating a particular food compared to the very high blood sugar response produced by the same amount of carbohydrate in the form of glucose sugar). Equal-carbohydrate portions of test foods and the reference food are used in GI experiments, because carbohydrate is the main component in food that causes the blood's glucose level to rise.

The night before each test session, the subjects ate a regular low-fat evening meal based on a carbohydrate-rich food, other than legumes, and then fasted for at least 10 hours overnight. The subjects were also required to avoid alcohol and unusual levels of food intake and physical activity for the whole day before each test session.

Measurement of the Subjects' Blood Glucose Responses

For each subject, the concentration of glucose in each of the eight whole blood samples collected from them during each test session was analysed in duplicate using a HemoCue® B-glucose photometric analyser employing a glucose dehydrogenase/mutarotase enzymatic assay (HemoCue AB, Ängelholm, Sweden). Each blood sample was collected into a plastic HemoCue® cuvette containing the enzymes and reagents for the blood glucose assay and then placed into the HemoCue analyser while the enzymatic reaction took place. Therefore, each blood sample was analysed immediately after it was collected.

For each of the 10 subjects, a two-hour blood glucose response curve was constructed for each of their test sessions using the average blood glucose concentrations for each of their eight blood samples. The two fasting blood samples were averaged to provide one baseline glucose concentration. The area under each two-hour blood glucose response curve (AUC) was then calculated in order to obtain a single number, which indicates the total increase in blood glucose during the two-hour test period in that subject as a result of ingesting that food. A glycaemic index (GI) value for each test sugar was then calculated for each subject by dividing their two-hour blood glucose AUC value for the test food by their average two-hour blood glucose AUC value for the reference food and multiplying by 100 to obtain a percentage score.

GI value (%)=Blood glucose AUC value for the test food×100

Average AUC value for the equal carbohydrate portion of the reference food

Due to differences in body weight and metabolism, blood glucose responses to the same food or drink can vary between different people. The use of the reference food to calculate GI values reduces the variation between the subjects' blood glucose results to the same food arising from these natural differences. Therefore, the GI value for the same food varies less between the subjects than their glucose AUC values for this food.

TABLE 2
GI for samples prepared in example 1

| Sample | GI (±SEM) | GI category |
|---|---|---|
| Reference | 100 ± 0 | High GI |
| Control sugar | 68 ± 3 | Medium GI |
| Sugar 1 | 53 ± 4 | Low GI |
| Sugar 2 | 70 ± 4 | High GI |

### Example 5

### Relationship Between GI and Polyphenol, Glucose, Fructose and Moisture Content

Increasing glucose and fructose in low GI sugar can affect the GI of sugar. In many unrefined sugars, as sucrose content decreases reducing sugar content increases. The increase in reducing sugars can increase the GI of the unrefined sugar. This effect is counterintuitive and unexpected. Most consumers understand that less refined products are healthier or better for you. However, that is not necessarily the case for unrefined sugar. The healthiest sugars minimise reducing sugar content without refining our all the polyphenols responsible for the low GI. There is a “sweet spot” in the extent to which sugar is refined where GI remains low. The inventors of the present invention have researched less refined sugars by varying the extent of the massecuite washing. Too much washing removed the majority of polyphenol content and increased the GI. Too little washing resulted in a higher reducing sugar content, which is thought to overpower the GI lowering effect of the polyphenols and increase the GI of the sugar.

The low GI sweet spot was demonstrated by graphing the results of the sugars in Table 3 below. This graph demonstrates that at least 22 mg CE/100 mg sucrose needs to be retained during sugar processing to produce a low GI sugar. If additional polyphenols are present but reducing sugars are too high then GI effect is removed. Respraying molasses back onto refined white and less refined raw sugars to produce a brown sugar may therefore not be an effective strategy to reduce GI.

TABLE 3
Example sugars

| Polyphenols | | | Sucrose | Glucose | Fructose | Moisture |
|---|---|---|---|---|---|---|
| mg/100 g | GI (%) | SE | (%) | (%) | (%) | (%) |
| 0 | 68 | 3 | 99.9 | 0 | 0 | 0.075 |
| 15-19 | 66 | 3 | 99.1 | 0.04 | 0.04 | 0.09 |
| 22-32 | 50 | 5 | 95.2 | 0.11 | 0.09 | 0.36 |
| 60-70 | 70 | 4 | 89.5 | 0.17 | 0.21 | 0.65 |

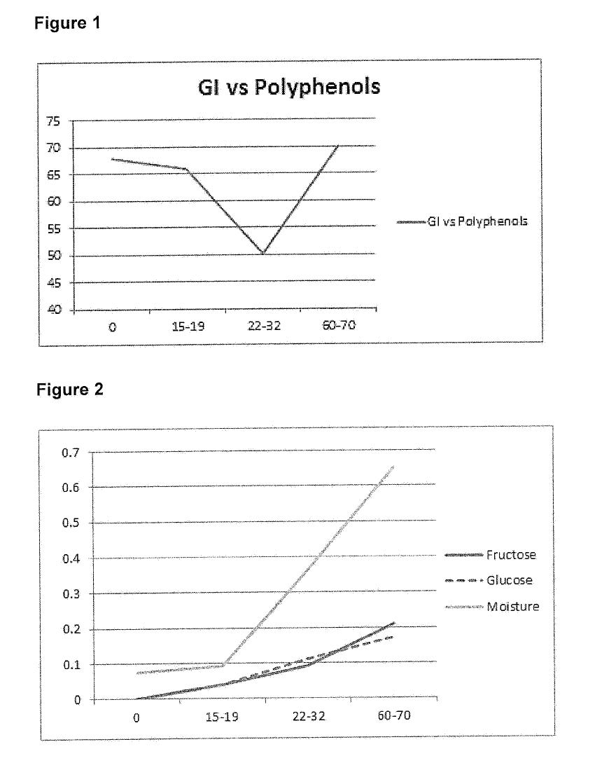

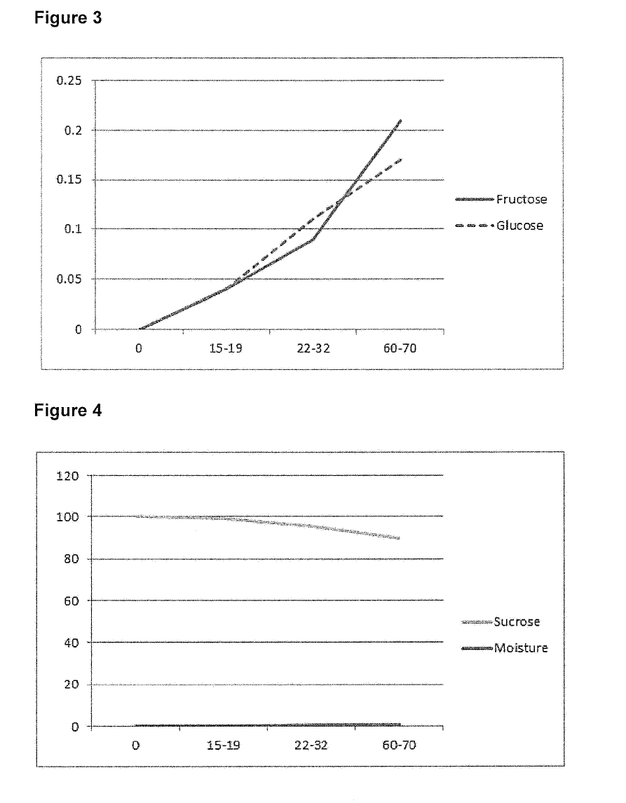

FIG. 1 shows a graph of GI v polyphenol content of these sugars. This figure shows sugars have low GI at about 22-32 mg CE/100 g polyphenols. FIG. 2 graphs moisture, glucose and fructose content each separately against polyphenol content. FIG. 3 graphs glucose and fructose content against polyphenol content for these example sugars. FIGS. 2 and 3 illustrate why GI is higher in sugars with higher polyphenol content (ie sugars that would otherwise be expected to remain low GI). As the polyphenol content increases above about 22-32 mg CE/100 g polyphenols, the reducing sugar content of the sugar increases, the sugar becomes hygroscopic so moisture content increases and the higher GI of the glucose and fructose begin to raise the GI of the sugar as a whole despite the GI lowering polyphenols.

### Example 6

### Washing of Massecuite to Desired Polyphenol Content

Ten massecuite samples were prepared at two different sugar mills designated “Mill 1” and “Mill 2”. The polyphenol content of each sample was determined (see Example 2). The massecuite samples were washed until they were the depth of colour that is associated with the desired polyphenol content (ie roughly 500 to 2000 ICUMSA) and the polyphenol content measured. The results are in Table 4 below. The skilled person will understand that if the polyphenol content remains too high after the wash, a second wash is possible. The results for each sample are below. The polyphenol content of several of the samples below is too low. Those samples would have to be discarded. It is usual for some sugars prepared at a sugar mill to not meet specifications for various reasons.

TABLE 4
Example sugars

| | | | Polyphenol content |
|---|---|---|---|
| | Massecuite | Less refined | removed during |
| | polyphenols | sugar polyphenols | massecuite washing |
| Sample | (mg CE/100 g) | (mg CE/100 g) | (mg CE/100 g) |
| Mill 1 - 1 | 316.8 | 23.1 | 293.7 |
| Mill 1 - 2 | 312 | 24.3 | 287.7 |
| Mill 1 - 3 | 287.6 | 25.8 | 261.8 |
| Mill 1 - 4 | 291.8 | 18.6 | 273.2 |
| Mill 1 - 5 | 314.6 | 20.5 | 294.1 |
| Mill 1 - 6 | 301.8 | 24.1 | 277.7 |
| Mill 1 - 7 | 277.3 | 17.1 | 260.2 |
| Mill 1 - 8 | 262.3 | 19.5 | 242.8 |
| Mill 1 - 9 | 305.4 | 18.2 | 287.2 |
| Mill1 - 10 | 314.7 | 23.6 | 291.1 |
| Mill 2 - 1 | 283 | 24 | 259 |
| Mill 2 - 2 | 267.2 | 24.2 | 243 |
| Mill 2 - 3 | 246.4 | 24.6 | 221.8 |
| Mill 2 - 4 | 262.2 | 20.2 | 242 |
| Mill 2 - 5 | 270.8 | 30.2 | 240.6 |
| Mill 2 - 6 | 282.6 | 25 | 257.6 |
| Mill 2 - 7 | 269.1 | 23.5 | 245.6 |
| Mill 2 - 8 | 256.8 | 21.2 | 235.6 |
| Mill 2 - 9 | 268.9 | 22.9 | 246 |
| Mill 2 - 10 | 276 | 21.6 | 254.4 |

### Example 7

### Relationship Between Polyphenol Content and Conductivity/ICUMSA

Further sugar particles were prepared as described in Example 6. Their polyphenol content, conductivity and ICUMSA were measured and the linear relationship between the two confirmed. The results are in Table 5 below.

ICUMSA was measured with a Metrohm NIRS XDS spectrometer with a ProFoss analysis system. Conductivity was measured under standard conditions by the conductivity meter InPro 7000-VP Conductivity sensor by Mettler Toledo.

TABLE 5
Features of sugars prepared

| Polyphe- | Conduc- | | Polyphe- | Conduc- | |
|---|---|---|---|---|---|
| nols (mg | tivity | | nols (mg | tivity | |
| CE/100 g) | (μS/cm) | ICUMSA | CE/100 g) | (μS/cm) | ICUMSA |
| 15.88 | 101 | 665 | 31.88 | 210 | 1390 |
| 16.57 | 110 | 620 | 32.19 | 220 | 1560 |
| 17.73 | 100 | 625 | 33.76 | 240 | 1660 |
| 17.87 | 120 | 710 | 34.85 | 270 | 1485 |
| 18.10 | 110 | 915 | 34.86 | 250 | 1880 |
| 18.43 | 110 | 815 | 35.24 | 250 | 1510 |
| 18.53 | 130 | 915 | 37.71 | 300 | 1695 |
| 18.87 | 100 | 760 | 38.13 | 290 | 1600 |
| 19.45 | 120 | 785 | 39.58 | 280 | 1690 |
| 19.71 | 130 | 870 | 41.72 | 310 | 1750 |
| 20.71 | 130 | 780 | 41.97 | 300 | 1725 |
| 20.97 | 150 | 750 | 84.32 | 650 | 3715 |
| 21.31 | 140 | 960 | 26.7 | 180 | 1520 |
| 21.44 | 150 | 960 | 35 | 250 | 2240 |
| 21.88 | 130 | 865 | 26.6 | 200 | 1740 |
| 22.26 | 120 | 715 | 29.1 | 224 | 1870 |
| 22.47 | 180 | 1320 | 81 | 614 | 4090 |
| 22.53 | 130 | 750 | 65.9 | 500 | 3240 |
| 22.84 | 130 | 735 | 64 | 487 | 3170 |
| 24.02 | 160 | 1100 | 52.8 | 430 | 2520 |
| 24.05 | 180 | 1045 | 29.3 | 213 | 1470 |
| 24.15 | 140 | 990 | 34.8 | 300 | 1610 |
| 24.38 | 170 | 985 | 33.3 | 278 | 1650 |
| 24.58 | 160 | 1050 | 34.8 | 280 | 1700 |
| 24.84 | 170 | 1100 | 32 | 257 | 1530 |
| 25.07 | 180 | 1055 | 28.5 | 202 | 1440 |
| 25.13 | 210 | 1235 | 39.1 | 289 | 1980 |
| 25.47 | 170 | 1255 | 35 | 276 | 1870 |
| 25.56 | 180 | 1175 | 35.1 | 279 | 1880 |
| 25.59 | 180 | 1140 | 32.4 | 267 | 1740 |
| 25.80 | 160 | 1120 | 37.9 | 289 | 1970 |
| 25.82 | 190 | 930 | 29.9 | 199 | 1520 |
| 26.01 | 180 | 1080 | 29.7 | 202 | 1490 |
| 26.26 | 170 | 1145 | 31.3 | 213 | 1740 |
| 26.50 | 160 | 1065 | 76 | 600 | 4030 |
| 26.68 | 190 | 1170 | 28 | 189 | 1460 |
| 26.75 | 180 | 1175 | 66 | 513 | 3255 |
| 26.98 | 190 | 1100 | 32 | 216 | 1721 |
| 27.05 | 190 | 1130 | | | |
| 28.26 | 210 | 1280 | | | |
| 28.46 | 210 | 1250 | | | |
| 28.53 | 210 | 1080 | | | |
| 29.02 | 210 | 1230 | | | |
| 29.11 | 190 | 1135 | | | |
| 29.96 | 200 | 1295 | | | |
| 30.67 | 200 | 1320 | | | |
| 31.47 | 210 | 1495 | | | |
| 31.58 | 210 | 1545 | | | |

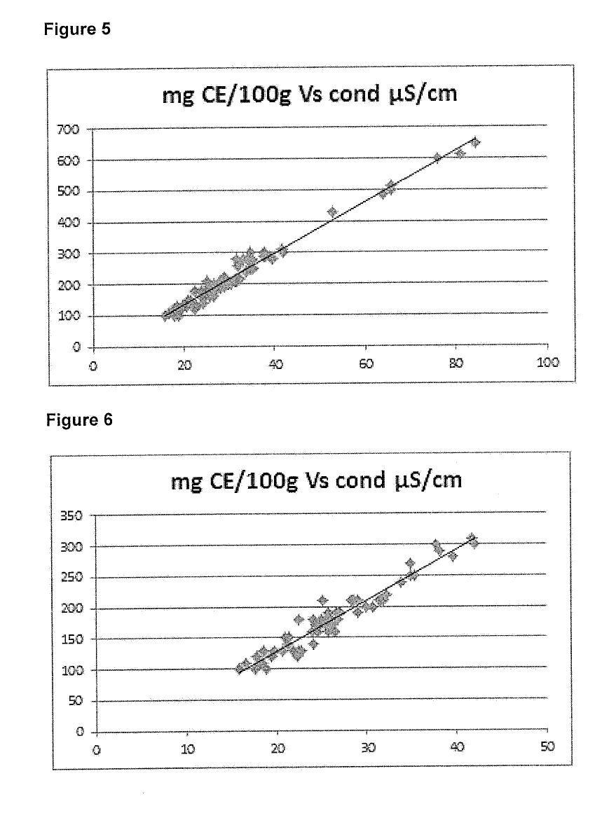

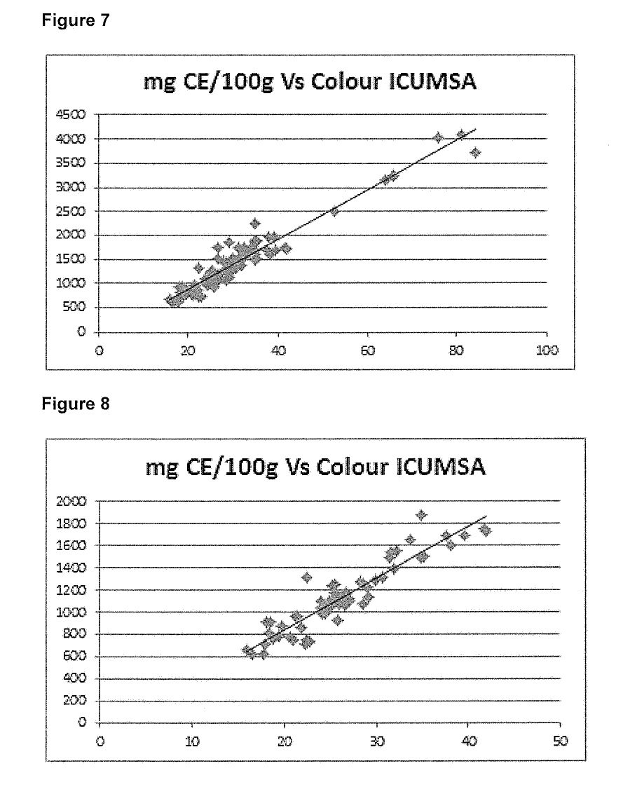

The relationship between the polyphenol content of the sugar prepared and the ICUMSA/conductivity of that sugar was graphed to show a linear relationship between polyphenol content and ICUMSA/conductivity. The graphs are in FIGS. 5 to 8.

### Example 8

### Relationship Between Polyphenol Content and Antioxidant Activity

Further sugar particles were prepared as described in Example 6 and various parameters of the sugar particles measured. The results are in Table 6 below. Some of the methods of measurement are as described elsewhere. Methods for measuring antioxidant activity and t-Aconitic acid are standard and well known in the art.

TABLE 6
Features of prepared sugars

| | Total | Antioxidant | t- | | | |
|---|---|---|---|---|---|---|
| | phenolics | activity | Aconitic | | Reducing | |
| Sample | (mg | (mg | acid | Sucrose | Sugars | Colour |
| No | CE/100 g) | GAE/100 g) | (mg/100 g) | (mg/100 g) | (mg/100 g) | ICUMSA |
| 1 | 26.7 | 8.5 | 32.4 | 98.94 | 0.23 | 1520 |
| 2 | 35 | 10.7 | 37.8 | 98.72 | 0.25 | 2240 |
| 3 | 26.6 | 8.2 | 25 | 98.93 | 0.23 | 1740 |
| 4 | 29.1 | 9.1 | 34.3 | 98.87 | 0.21 | 1870 |
| 6 | 81 | 24.6 | 89.8 | 97.35 | 0.65 | 4090 |
| 7 | 65.9 | 21.2 | 81.7 | 97.78 | 0.56 | 3240 |
| 8 | 64 | 20.1 | 76.4 | 97.75 | 0.54 | 3170 |
| 9 | 52.8 | 16.9 | 59.9 | 98.21 | 0.41 | 2520 |
| 10 | 29.3 | 9.3 | 36.7 | 99.06 | 0.18 | 1470 |
| 11 | 34.8 | 11 | 40.9 | 99 | 0.21 | 1610 |
| 12 | 33.3 | 10.6 | 39.5 | 98.96 | 0.2 | 1650 |
| 13 | 34.8 | 11.1 | 44.4 | 98.92 | 0.23 | 1700 |
| 14 | 32 | 10.3 | 36.2 | 99.04 | 0.2 | 1530 |
| 15 | 28.5 | 9.3 | 34.1 | 99.1 | 0.18 | 1440 |
| 16 | 39.1 | 12.1 | 44.5 | 98.84 | 0.26 | 1980 |
| 17 | 35 | 11.2 | 39.8 | 99.01 | 0.21 | 1870 |
| 18 | 35.1 | 11.1 | 38.8 | 98.91 | 0.22 | 1880 |
| 19 | 32.4 | 10.8 | 40.1 | 99.04 | 0.2 | 1740 |
| 20 | 31.7 | 10.3 | 38.3 | 99.02 | 0.2 | 1690 |
| 21 | 34.2 | 11 | 38.8 | 99 | 0.22 | 1770 |
| 22 | 37.9 | 12.1 | 42 | 98.86 | 0.26 | 1970 |
| 23 | 29.9 | 9.7 | 34.6 | 99.15 | 0.18 | 1520 |
| 24 | 29.7 | 9.4 | 36.2 | 99.11 | 0.18 | 1490 |
| 25 | 31.3 | 10.4 | 39.2 | 98.18 | 0.22 | 1740 |
| 26 | 76 | 25 | 84 | | | 4030 |
| 27 | 28 | 10 | 32 | | | 1460 |
| 28 | 66 | 21 | 77 | 98 | 0.540 | 3255 |
| 29 | 32 | 10 | 38 | 99 | 0.214 | 1721 |

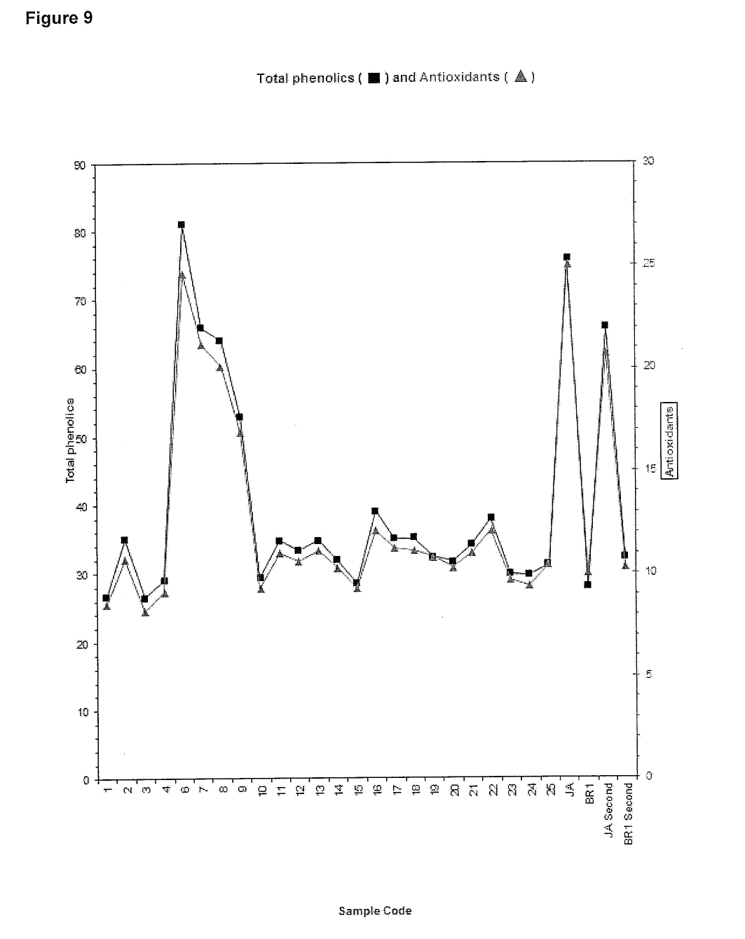

The relationship between the polyphenol content of the sugar prepared and the antioxidant activity of that sugar was graphed. The graph is in FIG. 9.

### Example 9

### Relationship Between Polyphenol Content and Mineral Content

The sugar particles from Example 8 were also analysed to determine the amounts of various minerals. The results are in Table 7 below. Some of the methods of measurement are as described elsewhere. Methods for measuring mineral content are standard and well known in the art.

TABLE 7
Content of example sugars

| | Total | | | | | | | | |
|---|---|---|---|---|---|---|---|---|---|
| Sam- | phenolics | Element | | | | | | | |
| ple | (mg | (mg/kg) | | | | | | | |
| No | CE/100 g) | Na | K | Ca | Mg | Fe | PO₄ | SO₄ | Cl |
| 1 | 26.7 | 67 | 427 | 171 | 28 | 35 | 17 | 617 | 100 |
| 2 | 35 | 81 | 555 | 213 | 44 | 32 | 43 | 627 | 122 |
| 3 | 26.6 | 51 | 390 | 145 | 29 | 52 | 22 | 530 | 77 |
| 4 | 29.1 | 55 | 527 | 159 | 32 | 21 | 23 | 646 | 112 |
| 6 | 81 | 97 | 1810 | 453 | 119 | 19 | 43 | 737 | 584 |
| 7 | 65.9 | 31 | 1535 | 367 | 111 | 29 | 35 | 751 | 435 |
| 8 | 64 | 70 | 1463 | 419 | 92 | 24 | 19 | 704 | 418 |
| 9 | 52.8 | 64 | 1106 | 308 | 74 | 74 | 28 | 680 | 277 |
| 10 | 29.3 | 95 | 557 | 168 | 38 | 15 | 14 | 672 | 152 |
| 11 | 34.8 | 45 | 606 | 182 | 42 | 12 | 15 | 735 | 182 |
| 12 | 33.3 | 80 | 562 | 407 | 52 | 13 | 12 | 704 | 173 |
| 13 | 34.8 | 82 | 660 | 270 | 59 | 14 | 15 | 652 | 158 |
| 14 | 32 | 81 | 577 | 149 | 52 | 14 | 21 | 680 | 144 |
| 15 | 28.5 | 66 | 506 | 135 | 44 | 16 | 14 | 598 | 117 |
| 16 | 39.1 | 47 | 645 | 206 | 57 | 17 | 28 | 590 | 185 |
| 17 | 35 | 55 | 602 | 292 | 58 | 17 | 33 | 768 | 161 |
| 18 | 35.1 | 41 | 581 | 203 | 54 | 14 | 17 | 766 | 145 |
| 19 | 32.4 | 83 | 575 | 189 | 57 | 14 | 14 | 884 | 121 |
| 20 | 31.7 | 111 | 636 | 236 | 63 | 15 | 27 | 813 | 127 |
| 21 | 34.2 | 39 | 595 | 194 | 59 | 14 | 19 | 801 | 133 |
| 22 | 37.9 | 55 | 601 | 195 | 64 | 51 | 22 | 804 | 129 |
| 23 | 29.9 | 49 | 552 | 183 | 53 | 16 | 19 | 881 | 109 |
| 24 | 29.7 | 18 | 493 | 139 | 54 | 13 | 14 | 767 | 101 |
| 25 | 31.3 | 48 | 596 | 176 | 66 | 15 | 19 | 816 | 129 |
| 26 | 76 | 51 | 1189 | 323 | 134 | 23 | 47 | 599 | 419 |
| 27 | 28 | 26 | 331 | 207 | 45 | 11 | 20 | 540 | 85 |
| 28 | 66 | 66 | 1479 | 387 | 99 | 37 | 31 | 718 | 429 |
| 29 | 32 | 62 | 562 | 201 | 50 | 21 | 20 | 718 | 134 |

1. Food grade sugar particles comprising sucrose crystals, reducing sugars and polyphenols, wherein the sugar particles comprise about 0 to about 0.5 g/100 g reducing sugars; and
about 20 mg/100 g to about 45 mg/100 g polyphenols; and
wherein the sugar particles have a glucose based glycaemic index of less than 55.

2. The sugar particles of claim 1, wherein a first proportion of the polyphenols are entrained within the sucrose crystals and a second proportion of he polyphenols is distributed on the surfaces of the sucrose crystals.

3. The sugar particles of claim 2, wherein the proportion of the polyphenols entrained within the sugar crystals is about 25% to 30% of the total polyphenol content of the sugar particles.

4. A method for preparing sugar particles comprising washing massecuite to produce sugar particles, wherein the massecuite includes sucrose crystals, polyphenols and reducing sugars, wherein the wash removes an amount of polyphenols and an amount of reducing sugars from the massecuite, wherein the sugar particles comprise about 0 to 0.5 g/100 g reducing sugars and about 20 mg/100 g to about 45 mg/100 g polyphenols and wherein the sugar particles have a glucose based glycaemic index of less than 55.

5. A method for preparing sugar particles according to claim 4, wherein the wash is ceased when the sugar particles comprise 0 to 0.5 g/100 g reducing sugars and less than about 45 mg CE/100 g polyphenols and additional polyphenols are added to the sugar particles to prepare sugar comprising about 20 mg CE/100 g to about 45 mg CE/100 g polyphenols.

6. A method for preparing sugar particles according to claim 4, wherein the wash is ceased when the sugar particles comprise 0 to 0.5 g/100 g reducing sugars and about 20 mg/100 g to about 45 mg/100 g polyphenols and no polyphenols or reducing sugars are either added to or removed from the sugar particles following the wash.

7. The method of claim 4, wherein the massecuite comprises 200-400 mg/100 g polyphenols.

8. The method of claim 4, wherein the amount of polyphenols removed from the massecuite during the wash is 165-380 mg CE/100 g.

9. The method of claim 4, wherein the sugar particles fall within the maximum residue limits for chemicals set out in Schedule 20 of the Australian Food Standards Code in force July 2017.

10. (canceled)

11. The method of claim 4, wherein the sugar particles comprise about 25 mg/100 g to about 35 mg/100 g polyphenols and/or about 98 to about 99.5% w/w sucrose and/or about 0.02% to about 0.6% w/w moisture.

12-18. (canceled)

19. The sugar particles of claim 1, wherein the sugar particles comprise about 0 g/100 g to about 0.2 g/100 g reducing sugars.

20. The sugar particles of claim 1, wherein the sugar particles comprise about 25 mg/100 g to about 35 mg/100 g polyphenols.

21. The sugar particles of claim 1, wherein the sugar particles comprise about 98 to about 99.5% w/w sucrose.

22. The sugar particles of claim 1, wherein the polyphenols include tricin, luteolin and/or apigenin.

23. The sugar particles of claim 1, wherein the sugar particles have a glucose based glycaemic index of about 50.

24. The sugar particles of claim 1, wherein the sugar particles further comprise moisture content of the sugar particles is about 0.02% to about 0.6% w/w.

25. The sugar particles of claim 9, wherein the moisture content of the sugar particles is about 0.1% to about 0.2% wlw.

26. The sugar particles of claim 9, wherein the moisture content of the sugar particles is 0.02% to 0.7% after 6 months storage at room temperature and 40% relative humidity.

27. The sugar particles of claims 9, wherein the increase in the moisture content of the sugar particles is a maximum of 0.3% wlw over 2 years.

28. The sugar particles of claim 1, wherein the sugar particles fall within the maximum residue limits for chemicals set out in Schedule 20 of the Australian Food Standards Code in force July 2017.
